(19) United States
(12) Patent Application Publication
(10) Pub. No.: US 2023/0270061 A1
(43) Pub. Date: Aug. 31, 2023

(54) IRRIGATING PLANTER ASSEMBLY

(71) Applicant: Tercio International Limited, Hong Kong (HK)

(72) Inventors: Muhammad Shakeel Ahmad, Kuala Lumpur (MY); Hiu Yin Yu, Hong Kong (HK)

(73) Assignee: Tercio International Limited, HONG KONG (HK)

(21) Appl. No.: 17/742,152

(22) Filed: May 11, 2022

(30) Foreign Application Priority Data
Feb. 25, 2022 (MY) PI2022001061

(51) Int. Cl. A01G 27/06

(52) U.S. Cl. CPC A01G 27/06

(57) ABSTRACT

An irrigating planter assembly (1) including a base unit (2) to receive and hold water, a hygroscopic unit (3) in fluid communication with the base unit (2) and water vapor condensing means (4) from either or both units (2, 3) of the assembly (1), wherein the base unit (2), hygroscopic unit (3) and water vapor condensing means (4) form an enclosed chamber (5) to contain moisture (32) evaporated therein for collection in the base unit (2) in the form of condensed water (6).

### CROSS-REFERENCE TO RELATED APPLICATION

The instant application claims priority to Malaysia Patent Application Serial No. PI2022001061 filed Feb. 25, 2022, the entire specification of which is expressly incorporated herein by reference.

### FIELD OF THE INVENTION

The present invention relates to an irrigating planter assembly and more particularly to an irrigating planter assembly wherein water is extracted from the atmosphere by high moisture absorption of hygroscopic material and subsequently evaporation thereof via a “solar still” effect and fed from the assembly to a plant by wicking capillary action.

### BACKGROUND OF THE INVENTION

To irrigate is to water crops or plants by bringing in water from pipes, canals, sprinklers or other man-made means, rather than completely relying on rainfall alone. Geographical locations having sparse or seasonal rainfall may not be able to sustain agriculture without employment of irrigation. In areas having substantially irregular precipitation, irrigation helps to improve crop growth and quality which allows farmers to grow crops on a consistent schedule, thereby creating reliable food supplies. Historically, ancient civilizations in many parts of the world have adapted and practiced irrigation in their strictest. The earliest form of irrigation involves manual workers carrying buckets of water from wells or rivers to pour on their crops. As better techniques developed, irrigation canals, dams, dikes and water storage facilities were built. Nevertheless, techniques are not viable in locations that are dry and hot such as in the desert.

Modern irrigation systems use reservoirs, tanks and wells to supply water to the crops. Other examples include canals or pipelines to carry water from reservoirs to crop fields. Canals and pipelines often rely on the force of gravity which pumps water from the reservoirs to the crop fields. There are several modern irrigation techniques that are widely established in the agriculture industries. One common class of irrigation techniques includes surface irrigation in which water is distributed over the ground surface by gravity flow where water is introduced into level or graded furrows using siphons, gated pipes or turnout structures to allow water to advance across the field. Sprinkler irrigation is widely used in agricultural activities whereby water is sprayed or sprinkled through the air like rain-like drops. On the other hand, drip or trickle irrigation is a technique of micro irrigation wherein water is applied through emitters to the soil surface as drops of small streams. Subsurface irrigation consists of methods whereby irrigation water is applied below the soil surface depending on the depth of the water table.

A new class of irrigation technique known as capillary irrigation is a form of subsurface irrigation that employs the capillary action of a medium to deliver water to a plant from a water source at or below the base of the growing bed. Container-based sub-irrigated systems such as capillary mats, ebb and flow systems, capillary wicks and sub-irrigated planters are irrigation system that depends on capillary action. Capillary irrigation involves subsurface irrigation that rely on wicking action. Through capillary action, water slowly rises despite gravitational force whereby the water molecules cling to wicks and climb through tiny air chambers rising all the way to the soil line. These systems have been widely recommended in literature and guideline documents as they can facilitate in healthy plant growth while reducing environmental impact, water demand and irrigation effort.

Essentially, capillary irrigation systems assist in providing a time saving and convenient way to water landscapes, vegetation crops and the like. An example of such technology of capillary irrigation systems is depicted in U.S. Pat. No. 3,220,144 which discloses a planter comprising a reservoir to hold water, a soil and plant container mounted above the reservoir. The container has an opening in its base and a sand bed deployed below the container and above the floor of the reservoir whereby a path running from the sand bed to into the reservoir is formed for water in the reservoir to travel by capillary flow into the sand bed. Another technology related to capillary irrigation systems is disclosed in United States Patent Publication No. 20110162272 depicting a self-watering planter box comprising a platform above a water reservoir with open tubular legs extending from the platform into the reservoir allowing capillary action or wicking of water to plants on the platform. U.S. Pat. No. 6,226,921 also discloses a plant watering device for use in conjunction with a planting container having an enclosed water reservoir at the lower portion thereof and having a water fill tube communicating with the water reservoir. Additionally, a capillary wicking material is provided to wick water from the water reservoir to planting media within the planter.

Nevertheless, the abovementioned technologies exhibit a major drawback of requiring readily available supply of water for the capillary irrigation technique to operate, therefore are not feasible in areas that are relatively hot and dry. The present invention provides an irrigating assembly that does not require the aforementioned drawback.

### SUMMARY OF THE INVENTION

One aspect of the invention is to provide an irrigating planter assembly that communicates a slow feed of water into the ground to directly provide water to a growing plant. The irrigating planter assembly uses a wicking mechanism which slowly draws water from the irrigating planter assembly and transmits it to the roots of the growing plant.

Another aspect of the invention is to provide an irrigating planter assembly that employs the use of hygroscopic material to absorb atmospheric moisture and readily condensed inside the irrigating planter assembly due to “solar still” effect. The condensate is collected for irrigation purpose.

Still, one aspect of the invention is to provide an irrigating planter assembly that does not require periodic manual watering or refilling of water for irrigating the growing plant.

At least one of the preceding objects is met, in whole or in part, in which the embodiment of the present invention describes an irrigating planter assembly comprising a base unit to receive and hold water, a hygroscopic unit in fluid communication with the base unit and water vapor condensing means from either or both units of the assembly, wherein the base unit, hygroscopic unit and water vapor condensing means form an enclosed chamber to contain moisture evaporated therein for collection in the base unit in the form of condensed water.

In a preferred embodiment of the present invention, it is disclosed that the base unit and hygroscopic unit, each comprises a body having a bottom wall, a peripheral wall and a funnel member to accommodate a growing plant.

In a preferred embodiment of the present invention, it is disclosed that the base unit comprises a tank defined by the peripheral wall and the funnel member to hold water.

In a preferred embodiment of the present invention, it is disclosed that the bottom wall of the base unit is provided with an aperture to receive a wick for drawing water therefrom to the growing plant by capillary action.

Preferably, the wick is derived from a fibrous material selected from the group consisting of cotton, yarn, wood, jute or paper.

In a preferred embodiment of the present invention, the hygroscopic unit comprises an outer compartment and an inner compartment defined by a dividing wall positioned between the peripheral wall and the funnel member.

It is preferred that the outer compartment of the hygroscopic unit is adapted to hold a bed of hygroscopic material for absorbing moisture contained in the enclosed chamber.

Preferably, the hygroscopic material is silica gel.

It is also preferred that the inner compartment of the hygroscopic unit has a plurality of through-holes provided at the bottom wall thereof for channelling the condensed water droplets from the water vapor condensing means to the base unit.

Further embodiment of the present invention discloses that the hygroscopic unit comprises a bottom edge having a first recess circumferentially extending around the outer circumference of the peripheral wall thereof.

Further embodiment of the present invention also discloses that the base unit comprises a top edge having a second recess circumferentially extending around the inner circumference of the peripheral wall thereof.

Preferably, when the hygroscopic unit is arranged above the base unit, the first recess abuts against the second recess along the edges such that the hygroscopic unit and the base unit are mounted in an anchoring relationship.

In a preferred embodiment of the present invention, the water vapor condensing means has a top surface and a bottom surface that slopes towards the center thereof to define a drip edge whereby condensed water droplets accumulated on the bottom surface trickle into tank of the base unit.

Preferably, an opening is provided at the center of the water vapor condensing means to permit draining of water from the top surface thereof into the tank of the base unit.

One skilled in the art will readily appreciate that the present invention is well adapted to carry out the objects and obtain the ends and advantages mentioned, as well as those inherent therein. The embodiment described herein is not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 shows a perspective view of the irrigating planter assembly of the present invention.

FIG. 2 shows a side view of the irrigating planter assembly of the present invention.

FIG. 3 shows a cross-sectional side view of the irrigating planter assembly of the present invention depicting the cycle of irrigating a growing plant.

FIG. 4 shows a top perspective view of the base unit of the irrigating planter assembly of the present invention.

FIG. 5 shows a bottom perspective view of the base unit of the irrigating planter assembly of the present invention.

FIG. 6 shows a top perspective view of the hygroscopic unit of the irrigating planter assembly of the present invention.

FIG. 7 shows a bottom perspective view of the hygroscopic unit of the irrigating planter assembly of the present invention.

FIG. 8 shows a perspective view of the water vapor condensing means of the irrigating planter assembly of the present invention.

### DETAILED DESCRIPTION OF THE INVENTION

Hereinafter, the invention shall be described according to the preferred embodiments of the present invention and by referring to the accompanying description and drawings. However, it is to be understood that limiting the description to the preferred embodiments of the invention is merely to facilitate discussion of the present invention and it is envisioned that those skilled in the art may devise various modifications without departing from the scope of the appended claim.

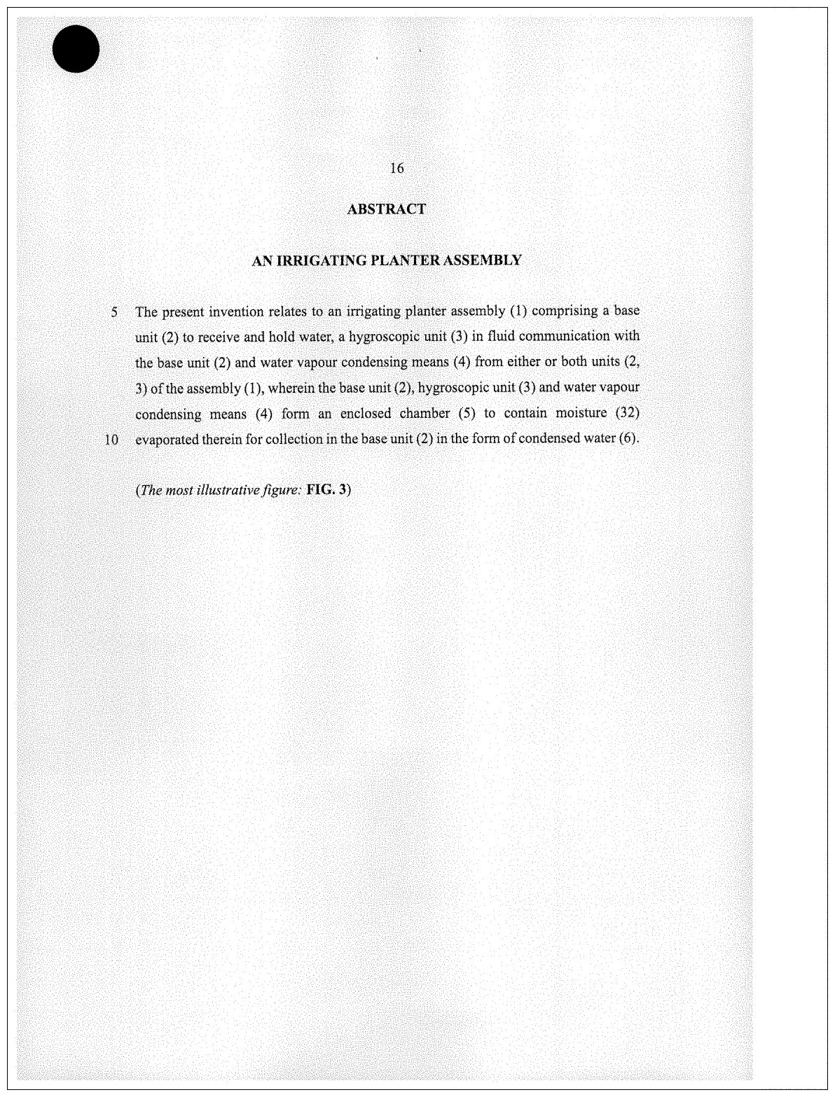

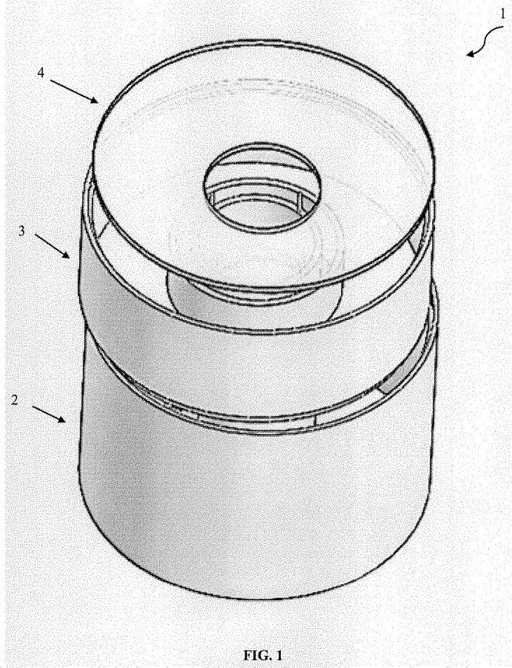

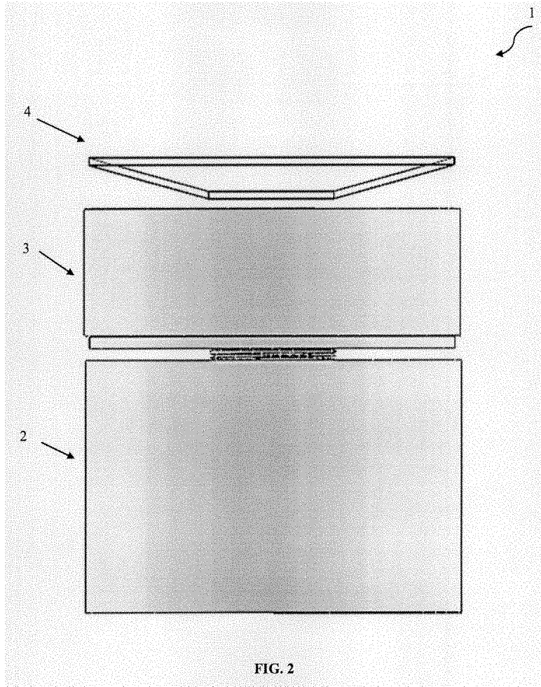

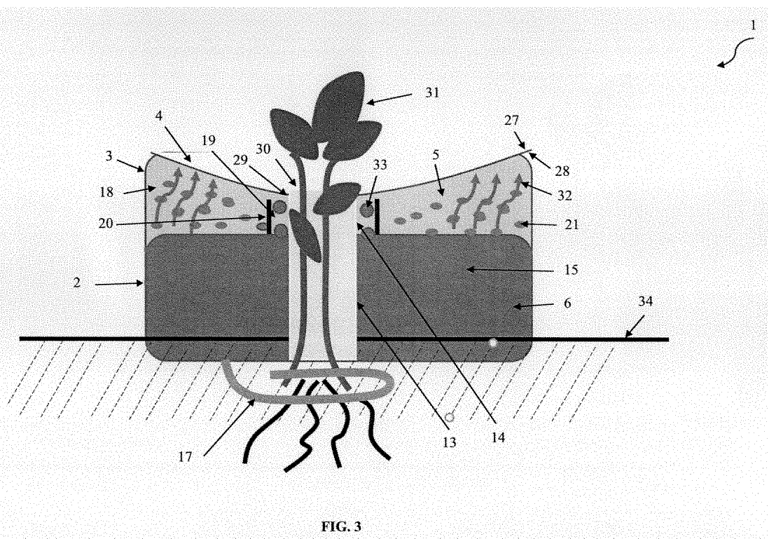

As shown in FIGS. 1 and 2, the present invention relates to an irrigating planter assembly generally indicated as 1, more particularly shown in FIG. 3 to water the roots 35 of a growing plant 31 with condensed water 6 from evaporated moisture 32.

Making reference to FIGS. 1 and 2, the irrigating planter assembly 1 comprises a base unit 2 to receive and hold water, a hygroscopic unit 3 in fluid communication with the base unit 2 and water vapor condensing means 4 from either or both units of the assembly 1. In an embodiment of the present invention, the hygroscopic unit 3 is preferably mounted directly on the base unit 2 and the water vapor condensing means 4 is preferably disposed on the hygroscopic unit 3 to cooperatively form an enclosed chamber 5, as clearly shown in the cross sectional view of the assembly 1 in FIG. 3. The enclosed chamber 5 is formed to contain moisture 32 evaporated therein for collection in the base unit 2 in the form of condensed water 6.

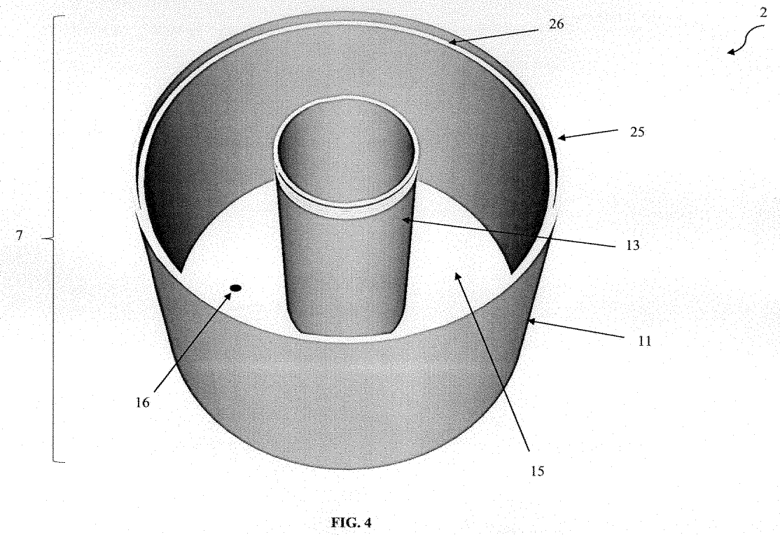

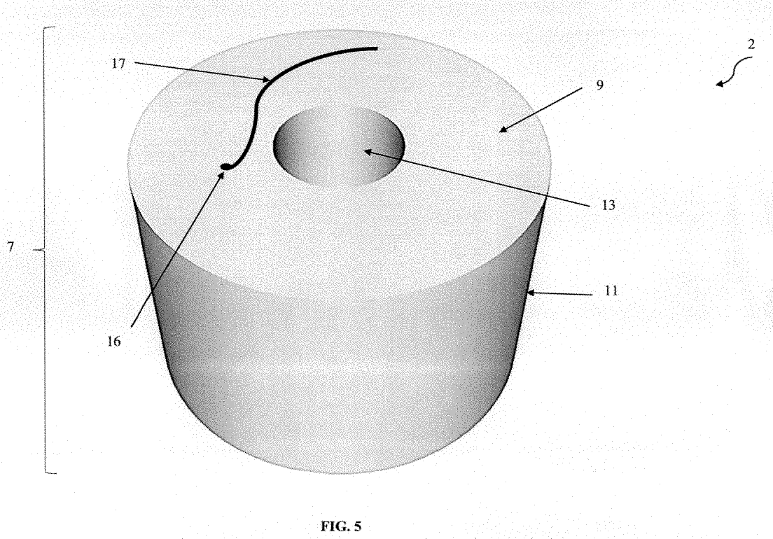

As best shown in FIGS. 4 and 5, the base unit 2 comprises a body 7 having a bottom wall 9, a peripheral wall 11 and a funnel member 13. It should be understood that the body 7 of the base unit 2 may be introduced in a variety of overall sizes and shapes which correspond to various sized plants. For illustrative purposes, the body 7 of the base unit 2 is ideally ring-shaped. The bottom wall 9 of the base unit 2 is substantially flat. The peripheral wall 11 of the base unit 2 extends vertically from the rim of the bottom wall 9 thereof and the funnel member 13 of the base unit 2 extends upward from the center of the bottom wall 9, thereby defining a tank 15 to hold water. Preferably, the funnel member 13 of the base unit 2 is hollow so that a growing plant 31 can be accommodated therein. By way of example, the base unit 2 is formed of a biodegradable material such as polymer or ceramic that is resistant to weathering.

As shown in FIG. 5 depicting the bottom view of the base unit 2, the bottom wall 9 of the base unit 2 is provided with an aperture 16 for communicating with the roots 35 of the growing plant 31 with the base unit 2. In order to allow communication of water from the tank 15 of the base unit 2 to the roots 35 of the growing plant 31 through the aperture 16, a wick 17 is provided. Preferably, the wick 17 is derived from a fibrous material that has wicking capillary action to transmit and draw water from the tank 15 of the base unit 2 to the roots 35 of the growing plant 31, which will be in contact with the wick 17. In a preferred embodiment of the present invention, the wick 17 may be derived from a fibrous material selected from the group consisting of cotton, yarn, wood, jute or paper. To provide additional support to the wick 17 on its surface, a coating which may be of any suitable material may be provided to prevent excessive planting media, for example soil from the ground, from excessively mixing with the wick 17. Alternatively, the wick 17 may be of cross-hatched, braided or any type of fine mesh configuration which would suitably maintain the wick 17 in a flattened condition and also to keep excessive amounts of soil from intermixing with the wick 17. To operate the wicking capillary action, the wick 17 is received and placed within the aperture 16 with suitable sizes, which one end of the wick 17 will be in contact with the water in the tank 15 of the base unit 2 and the other end extends to reach roots 35 of the growing plant 31.

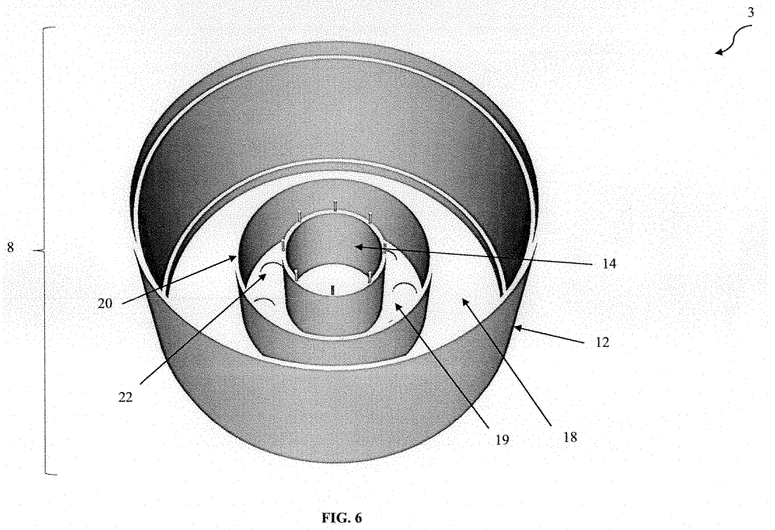

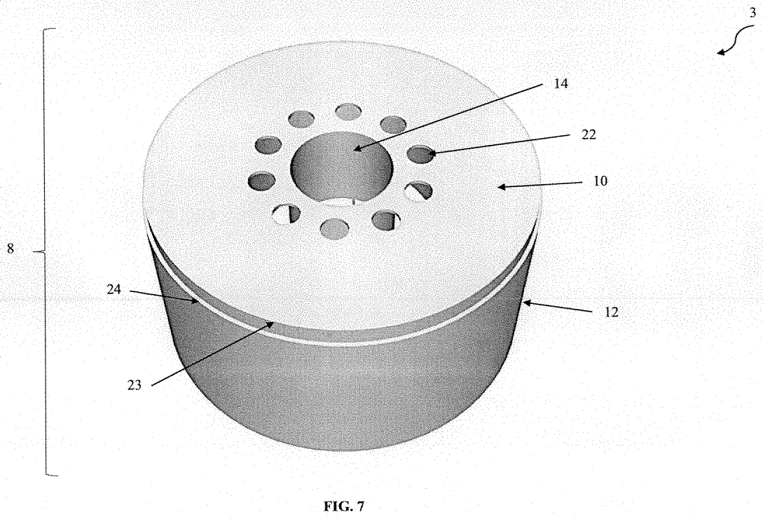

As shown in FIGS. 6 and 7, the hygroscopic unit 3 also comprises a body 8 having a bottom wall 10, a peripheral wall 12 and a funnel member 14 akin to the base unit 2. It should be understood that the body 8 of the base unit 3 may be introduced in a variety of overall sizes and shapes which correspond to various sized plants. Preferably, the shape of the body 8 of the hygroscopic unit 3 matches the shape of the body 7 of the base unit. The bottom wall 10 of the hygroscopic unit 3 is substantially flat. The peripheral wall 12 of the hygroscopic unit 3 extends vertically from the rim of the bottom wall 10 thereof and the funnel member 14 of the hygroscopic unit 3 extends upward from the center of the bottom wall 10. By way of example, the hygroscopic unit 3 is formed of a biodegradable material such as polymeric or ceramic that is resistant to weathering.

As best shown in FIGS. 3 and 6, the hygroscopic unit 3 comprises an outer compartment 18 and an inner compartment 19 defined by a dividing wall 20 positioned between the peripheral wall 12 and the funnel member 14. In the context of the present invention, the outer compartment 18 of the hygroscopic unit 4 is adapted to hold a bed of hygroscopic material 21 for absorbing moisture contained in the enclosed chamber 5 formed when the base unit 2, hygroscopic unit 3 and water vapor condensing means 4 are assembled together. For simplicity and economical concerns, the hygroscopic material 21 is preferably silica gel or silica beads. On the other hand, the inner compartment 19 of the hygroscopic unit 4 has a plurality of through-holes 22 provided at the bottom wall 10 thereof to allow channelling of condensed water droplets 33 from the water vapor condensing means 4 to the base unit 2.

The base unit 2 is configured to support the hygroscopic unit 3 when mounted thereon as shown in FIG. 1. Referring now to FIGS. 4 and 7, the hygroscopic unit 3 comprises a bottom edge 23 having a first recess 24 circumferentially extending around the outer circumference of the peripheral wall 12 of the hygroscopic unit 3 whereas the base unit 2 comprises a top edge 25 having a second recess 26 circumferentially extending around the inner circumference of the peripheral wall 11 of the base unit 2. The second recess 26 of the base unit 2 securely engages the first recess 24 of the hygroscopic unit 4 such that when the hygroscopic unit 3 is arranged on the base unit 2, the first recess 24 abuts against the second recess 26 along the edges 23, 25 so that the hygroscopic unit 3 and base unit 2 are mounted in a secure anchoring relationship. In this way, the enclosed chamber 5 formed in the assembly 1 is airtight. Furthermore, this prevents the hygroscopic unit 4 from being loosely mounted to and toppling from the base unit 2.

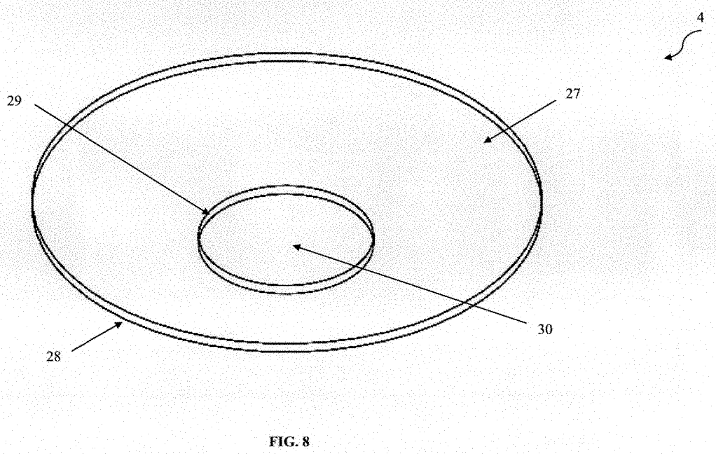

Referring back to FIG. 1, the assembly 1 comprises water vapor condensing means 4 preferably disposed on the hygroscopic unit 3. The water vapor condensing means 4 is provided to prevent or restrict any further escape of evaporated moisture 32 collected in the enclosed chamber 5 and then condenses the evaporated moisture back to water droplets due to temperature gradient. Preferably, the water vapor condensing means 4 permits the escape of a minute amount of evaporated moisture 32 from the hygroscopic unit 3. As seen in FIG. 8, the water vapor condensing means 4 has a top surface 27 and a bottom surface 28 that slopes towards the center of thereof so that a drip edge 29 is defined extending radially at the center of the water vapor condensing means 4. An opening 30 is further provided at the center of the water vapor condensing means 4 to permit draining of condensed water droplets or rainwater from the top surface 27 thereof into the inner compartment 19 of the hygroscopic unit 3 and therefore into the tank 15 of the base unit 2. Preferably, the opening 30 is dimensioned conveniently such that the drip edge 29 aligns towards the inner compartment 19 of the hygroscopic unit 3 so that condensed water droplets 33 accumulated on the bottom surface 28 of the water vapor condensing means 4 trickle into the inner compartment 19 of the hygroscopic unit 3. The opening 30 is also dimensioned to allow accommodation of the growing plant 31.

The above described assembly 1 functions in the following manner. As best illustrated in FIG. 3, the base unit 2 is placed in the ground 34 in surrounding relationship to a growing plant 31 accommodated and extending upwardly through the funnel member 13. The hygroscopic unit 3 is mounted on the base unit 2 and the water vapor condensing means 4 is disposed on the hygroscopic unit 3 such that evaporated moisture 32 is collected and contained in the enclosed chamber 5. The enclosed chamber 5 traps the evaporated moisture 32 and is readily absorbed by the bed of hygroscopic material 21 held in the inner compartment 19 of the hygroscopic unit 3. Due to the “solar still” effect leading to hothouse conditions in the enclosed chamber 5, the evaporated moisture 32 forms condensate that further forms condensed water droplets 33 on the bottom surface 28 of the water vapor condensing means 4. Ideally, the water vapor condensing means 4 is a glass plate, which has potential heat insulation capability, therefore enhancing the aforementioned “solar still” effect in the enclosed chamber 5.

Initial or periodic watering of the growing plant may be desirable under conventional circumstance but the necessity of such watering is minimized or obviated since considerable evaporated moisture will 32 be captured in the enclosed chamber 5. Combined with condensation of evaporated moisture 32 on the bottom surface 28 of the water vapor condensing means 4, water droplets 33 are formed thereon and trickle from the drip edge 29 thereof into the inner compartment 19 of the hygroscopic unit 3, and therefore into the tank 15 of the base unit 2 via the through-holes 22 in the inner compartment 19. It is also desirable to drain condensed water droplets formed on the top surface 27 of the water vapor condensing means 4 or rainwater into the inner compartment 19 of the hygroscopic unit 3 via the opening 30.

FIG. 3 shows that the base unit 2 is placed in the ground 34, with one end of the wick 17 connected to the bottom wall 9 of the base unit 2 via the aperture 16. The wick 17 is preferably juxtaposed and buried in the soil of the ground 34 with the other end thereof being extended towards the roots 35 of the growing plant 31. This feature permits the condensed water 6 collected in the tank 15 of the base unit 2 to be drawn therefrom and transmitted to the roots 35 of the growing plant 31 by wicking capillary action. In this way, the growing plant 31 is directly and reliably irrigated without the need for periodic refilling of water in the tank 15 of the base unit 2. Advantageously, the assembly 1 of the present invention provides consistent supply of water for irrigation extracted from atmospheric moisture.

The present disclosure includes as contained in the appended claims, as well as that of the foregoing description. Although this invention has been described in its preferred form with a degree of particularly, it is understood that the present disclosure of the preferred form has been made only by way of example and that numerous changes in the details of construction and the combination and arrangements of parts may be resorted to without departing from the scope of the invention.

What is claimed is:

1. An irrigating planter assembly, comprising:
a base unit to receive and hold water;
a hygroscopic unit in fluid communication with the base unit; and
water vapor condensing means from either or both units of the assembly;
wherein the base unit, hygroscopic unit and water vapor condensing means form an enclosed chamber to contain moisture evaporated therein for collection in the base unit in the form of condensed water.

2. The assembly according to claim 1, wherein the base unit and hygroscopic unit each comprises a body having a bottom wall, a peripheral wall and a funnel member to accommodate a growing plant.

3. The assembly according to claim 2, wherein the base unit comprises a tank defined by the peripheral wall and the funnel member to hold condensed water.

4. The assembly according to claim 3, wherein the bottom wall of the base unit is provided with an aperture to receive a wick for drawing condensed water therefrom to the growing plant by capillary action.

5. The assembly according to claim 4, wherein the wick is derived from a fibrous material selected from the group consisting of cotton, yarn, wood, jute or paper.

6. The assembly according to claim 2, wherein the hygroscopic unit comprises an outer compartment and an inner compartment defined by a dividing wall positioned between the peripheral wall and the funnel member.

7. The assembly according to claim 6, wherein the outer compartment of the hygroscopic unit is adapted to hold a bed of hygroscopic material for absorbing moisture contained in the enclosed chamber.

8. The assembly according to claim 7, wherein the hygroscopic material is silica gel.

9. The assembly according to claim 6, wherein the inner compartment of the hygroscopic unit has a plurality of through-holes provided at the bottom wall thereof for channelling condensed water droplets from the water vapor condensing means to the base unit.

10. The assembly according to claim 1, wherein the hygroscopic unit comprises a bottom edge having a first recess circumferentially extending around an outer circumference of a peripheral wall thereof.

11. The assembly according to claim 10, wherein the base unit comprises a top edge having a second recess circumferentially extending around the inner circumference of the peripheral wall thereof.

12. The assembly according to claim 11, wherein, when the hygroscopic unit is arranged above the base unit, the first recess abuts against the second recess along the edges such that the hygroscopic unit and the base unit are mounted in an anchoring relationship.

13. The assembly according to claim 1, wherein the water vapor condensing means has a top surface and a bottom surface that slopes towards the center thereof to define a drip edge whereby condensed water droplets accumulated on the bottom surface trickle into a tank of the base unit.

14. The assembly according to claim 1, wherein an opening is provided at the center of the water vapor condensing means to permit draining of water from the top surface thereof into a tank of the base unit.
